(19) United States
(12) Patent Application Publication
(10) Pub. No.: US 2022/0094744 A1
(43) Pub. Date: Mar. 24, 2022

(54) APPARATUS AND METHOD FOR PROVIDING INTEROPERABILITY OF MULTI-CLOUD SERVICES

(71) Applicant: Electronics and Telecommunications Research Institute, Daejeon (KR)

(72) Inventors: Young-Woo JUNG, Daejeon (KR); Dong-Jae KANG, Daejeon (KR); Byoung-Seob KIM, Daejeon (KR); Seok-Ho SON, Daejeon (KR); Soo-Young KIM, Daejeon (KR); Yun-Kon KIM, Daejeon (KR); Seung-Jo BAE, Daejeon (KR); Ji-Hoon SEO, Daejeon (KR); Byeong-Thaek OH, Daejeon (KR)

(73) Assignee: Electronics and Telecommunications Research Institute, Daejeon (KR)

(21) Appl. No.: 17/479,412

(22) Filed: Sep. 20, 2021

(30) Foreign Application Priority Data
Sep. 23, 2020 (KR) 10-2020-0123267
Sep. 2, 2021 (KR) 10-2021-0116928

(51) Int. Cl. H04L 29/08

(52) U.S. Cl. CPC H04L 67/1097

(57) ABSTRACT

Disclosed herein are an apparatus and method for providing interoperability of a multi-cloud service. The apparatus includes one or more processors and executable memory for storing at least one program executed by the one or more processors. The at least one program receives a service request for the multi-cloud service from a user client, creates a multi-cloud service in response to the service request, configures functions for interoperability between multiple cloud services in the multi-cloud service, and provides the multi-cloud service in which the functions for interoperability are configured to the user client.

### CROSS REFERENCE TO RELATED APPLICATIONS

This application claims the benefit of Korean Patent Application No. 10-2020-0123267, filed Sep. 23, 2020, and No. 10-2021-0116928, filed Sep. 2, 2021, which are hereby incorporated by reference in their entireties into this application.

### BACKGROUND OF THE INVENTION

### 1. Technical Field

The present invention relates generally to multi-cloud technology, and more particularly to technology for providing interoperability between cloud services in a multi-cloud environment.

### 2. Description of the Related Art

Because existing cloud technology uses cloud services provided by a single cloud or data center, it may be exposed to problems, such as the risk of service failure, limited resources provided by a single cloud service provider, vendor lock-in on a specific cloud service provider, and the like. In order to overcome these problems, multi-cloud technology that enables cloud services provided by multiple different cloud service providers to be simultaneously used is emerging as important technology.

In the case of cloud services provided by a single cloud service provider, interoperation therebetween can be provided using network configurations, application execution environment configurations, resource scheduling, and the like provided by the cloud service provider. However, when cloud services are provided by multiple different cloud service providers in a multi-cloud environment, there is a problem in which it is difficult for the cloud services to interwork with each other because the respective cloud services are provided by the different cloud service providers. Furthermore, because a cloud service customer who uses the cloud services is not aware of the internal configurations, such as network configurations, application execution environment configurations, resource scheduling, and the like provided by the respective cloud service providers, it is more difficult to realize interoperability between the cloud services provided by the multiple different cloud service providers.

That is, a multi-cloud environment in which various clouds of multiple types are used through interworking therebetween, rather than using a single cloud, requires special technology for providing interoperability between the cloud services provided by the multiple different cloud service.

Meanwhile, Korean Patent No. 10-2179459, titled “System for integrated management of multi-cloud and method therefor” discloses a system and method for integrated management of multiple clouds for providing uniform operation and management solutions in a multi-cloud environment in which two or more cloud vendors are supported.

### SUMMARY OF THE INVENTION

An object of the present invention is to provide interoperability through network and data connections between cloud services provided by multiple different cloud service providers.

Another object of the present invention is to solve various problems that are caused when a cloud service customer uses cloud services provided by a single cloud service provider.

In order to accomplish the above objects, an apparatus for providing interoperability of a multi-cloud service according to an embodiment of the present invention includes one or more processors and executable memory for storing at least one program executed by the one or more processors. The at least one program is configured to receive a service request for a multi-cloud service from a user client, to generate the multi-cloud service in response to the service request, to configure a function for interoperability between multiple cloud services for the multi-cloud service, and to provide the multi-cloud service in which the function for interoperability is configured to the user client.

Here, the at least one program may configure network connectivity by configuring a virtual network between the multiple cloud services and configure data connectivity by sharing a virtual storage unit between the multiple cloud services, thereby configuring the function for interoperability.

Here, the at least one program may configure the virtual network using network information included in the multiple cloud services.

Here, when changes in the network information of the cloud services are detected, the at least one program may store the changes in the network information and share the changes in the network information with the other cloud services.

Here, the at least one program may generate the virtual storage unit by connecting cloud storage units provided by cloud service providers of the multiple cloud services.

Here, the at least one program may generate the virtual storage unit having capacity required for the multi-cloud service based on resources of the cloud storage units.

Here, the at least one program may install virtual storage drivers in the multiple cloud services, thereby mounting the virtual storage unit with the multiple cloud services.

Also, in order to accomplish the above objects, a method for providing interoperability of a multi-cloud service, performed by an apparatus for providing the multi-cloud service, according to an embodiment of the present invention includes receiving a service request for a multi-cloud service from a user client, generating the multi-cloud service in response to the service request, configuring a function for interoperability between multiple cloud services for the multi-cloud service, and providing the multi-cloud service in which the function for interoperability is configured to the user client.

Here, configuring the function for interoperability may include configuring network connectivity by setting up a virtual network between the multiple cloud services; and configuring data connectivity by sharing a virtual storage unit between the multiple cloud services.

Here, configuring the network connectivity may be configured to configure the virtual network using network information included in the multiple cloud services.

Here, configuring the network connectivity may be configured such that, when changes in the network information of the cloud services are detected, the changes in the network information are stored and shared with the other cloud services.

Here, configuring the data connectivity may be configured to generate the virtual storage unit by connecting cloud storage units provided by cloud service providers of the multiple cloud services.

Here, configuring the data connectivity may be configured to generate the virtual storage unit having capacity required for the multi-cloud service based on resources of the cloud storage units.

Here, configuring the data connectivity may be configured to install virtual storage drivers in the multiple cloud services, thereby mounting the virtual storage unit with the multiple cloud services.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a view illustrating a multi-cloud environment according to an embodiment of the present invention;

FIG. 2 is a block diagram illustrating an apparatus for providing a multi-cloud service according to an embodiment of the present invention;

FIG. 3 is a block diagram illustrating in detail an example of the network connectivity provision unit illustrated in FIG. 2;

FIG. 4 is a block diagram illustrating in detail an example of the data connectivity provision unit illustrated in FIG. 2;

FIG. 5 is a flowchart illustrating a method for providing a multi-cloud service according to an embodiment of the present invention; and

FIG. 6 is a view illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations that have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present invention will be described in detail with reference to the accompanying drawings.

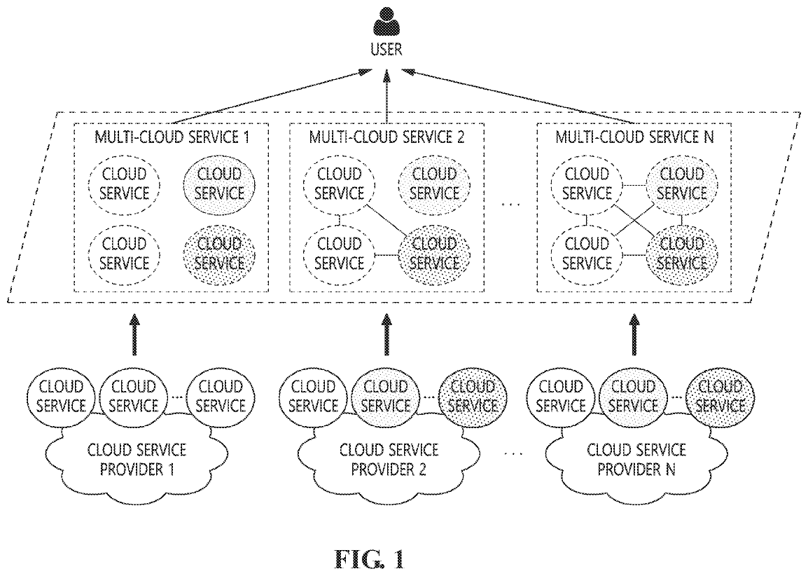

FIG. 1 is a view illustrating a multi-cloud environment according to an embodiment of the present invention.

Referring to FIG. 1, it can be seen that an environment in which multi-cloud services are provided consisting of cloud services provided by different cloud service providers is illustrated.

The apparatus for providing multi-cloud services may configure various forms of multi-cloud services.

Here, the apparatus for providing multi-cloud services may provide a multi-cloud service in the form of a simple group comprising multiple cloud services without a function for interoperability between the cloud services.

Here, the apparatus for providing multi-cloud services may provide a multi-cloud service in a form that includes a function for interoperability between only some of the cloud services in a group.

Here, the apparatus for providing multi-cloud services may provide a multi- cloud service in a form in which a function for interoperability between all of the cloud services in a group is provided.

Here, the function for interoperability between the cloud services may include network connectivity and data connectivity.

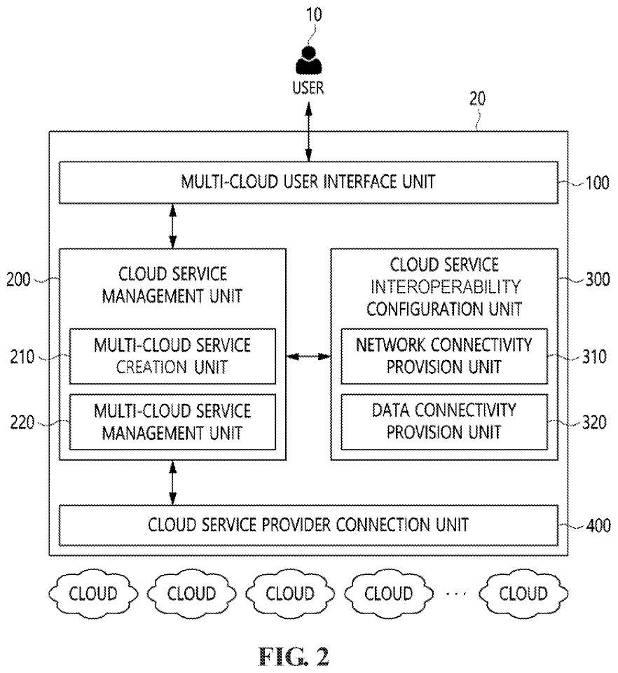

FIG. 2 is a block diagram illustrating an apparatus for providing multi-cloud services according to an embodiment of the present invention.

Referring to FIG. 2, the apparatus 20 for providing multi-cloud services according to an embodiment of the present invention includes a multi-cloud user interface unit 100, a cloud service management unit 200, a cloud service interoperability configuration unit 300, and a cloud service provider connection unit 400.

The multi-cloud user interface unit 100 may receive a service request for a multi-cloud service from a user client 10, and may return a created multi-cloud service.

The cloud service management unit 200 may create a multi-cloud service using multiple cloud services in response to the service request.

Here, the cloud service management unit 200 may include a multi-cloud service creation unit 210 and a multi-cloud service management unit 220.

When the service request includes a request for interoperability between cloud services, the multi-cloud service creation unit 210 may deliver an initially configured multi-cloud service to the cloud service interoperability configuration unit 300.

Here, the cloud service interoperability configuration unit 300 may configure a function for providing network connectivity or data connectivity between the cloud services in order to support interoperation therebetween, thereby creating a multi-cloud service including the interoperation function.

The multi-cloud service management unit 220 may manage the lifecycle of the created multi-cloud service.

Here, when the multi-cloud service includes interoperability functions, the multi-cloud service management unit 220 may check whether the interoperability functions are operating normally.

For the multi-cloud service received from the cloud service management unit 200, the cloud service interoperability configuration unit 300 may configure functions for interoperability between the cloud services and provide the same to the multi-cloud service management unit 220.

Here, the cloud service interoperability configuration unit 300 may include a network connectivity provision unit 310 and a data connectivity provision unit 320.

The network connectivity provision unit 310 may configure a virtual network between the multiple cloud services that constitute the multi-cloud service.

Here, the network connectivity provision unit 310 may provide network connectivity between the cloud services as in an environment of a single cloud service provider.

Here, the network connectivity provision unit 310 may set up a virtual network using network information included in the respective cloud services in order to avoid dependence on the different cloud service providers that actually provide the cloud services.

The data connectivity provision unit 320 may provide data connectivity such that the multiple cloud services constituting the multi-cloud service are able to share and use data as in an environment of a single cloud service provider.

Here, the data connectivity provision unit 320 connects cloud storage units provided by different cloud service providers so as to interwork with each other, thereby configuring and providing virtual storage.

Here, the data connectivity provision unit 320 may mount the same virtual storage with the multiple cloud services included in the multi-cloud service.

The cloud service provider connection unit 400 may connect to multiple different cloud service providers.

Here, in response to a request from the cloud service management unit 200, the cloud service provider connection unit 400 may deliver the cloud services generated and provided by the cloud service providers.

Also, the cloud service provider connection unit 400 may provide common interfaces for use in the same way for the different cloud service providers.

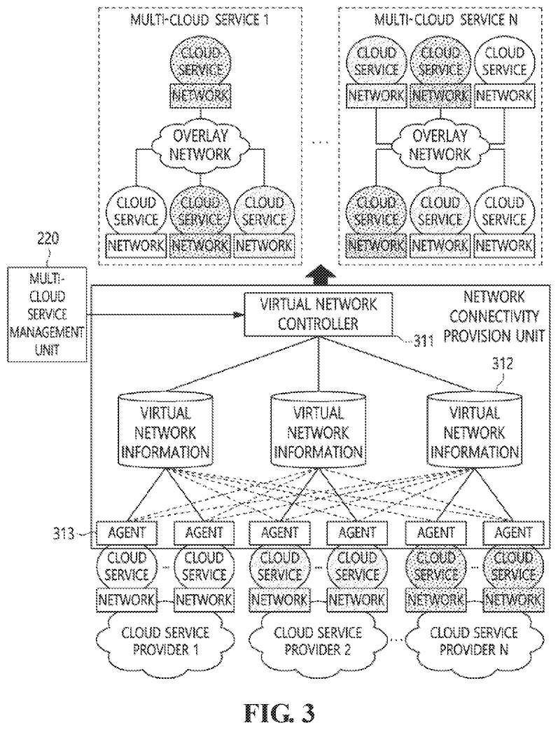

FIG. 3 is a block diagram illustrating in detail an example of the network connectivity provision unit illustrated in FIG. 2.

Referring to FIG. 3, the multi-cloud service management unit 220 may request the network connectivity provision unit 310 to configure network connectivity between the cloud services in an initial multi-cloud service, which are provided by multiple different cloud service providers.

The network connectivity provision unit 310 may install agents 313 in each of the cloud services, and the installed agents 313 may store network information of each cloud service in a virtual network information storage unit 312.

Here, each agent 313 may store the corresponding network information in a preset virtual network information storage unit 312.

Here, when the preset virtual network information storage unit 312 is not available, the agent 313 may store the corresponding network information in alternative virtual network information storage unit 312.

A virtual network controller 311 may check whether the multi-cloud service information provided by the multi-cloud service management unit 220 and the network information of all cloud services in the multi-cloud service are stored in the virtual network information storage units 312.

Here, when it confirms that the corresponding network information are stored in the virtual network information storage unit 312, the virtual network controller 311 may set up a new virtual network between the cloud services in the multi-cloud service and store the generated virtual network information in all of the virtual network information storage units 312.

Here, the agents 313 installed in the respective cloud services may check whether the setup of the virtual network is completed through the virtual network information storage units 312.

Here, when it confirms that the setup of the virtual network is completed, the agents 313 may send/receive packets to/from other cloud services in the multi-cloud service, based on the configured virtual network information.

Also, the agents 313 may periodically check whether the network information of the cloud services are changed, because the network information of the cloud service may be subject to change.

Here, when it detects a change in the network information, the agent 313 may store the corresponding network information in the virtual network information storage unit 312.

Here, the virtual network controller 311 periodically checks all of the virtual network information storage units 312. When it detects changes in the network information of the cloud services, the virtual network controller 311 changes the virtual network information based on the changes in the network information and stores the same in all of the virtual network information storage units 312, thereby sharing the change in the network information with other cloud services in the multi-cloud service.

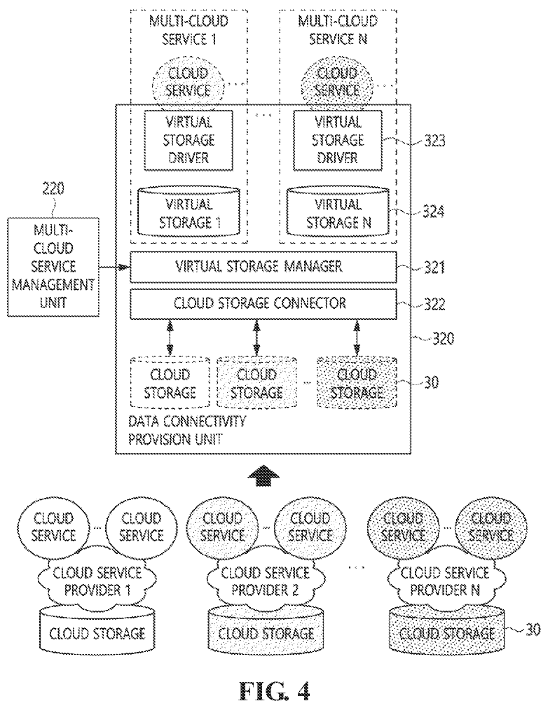

FIG. 4 is a block diagram illustrating in detail an example of the data connectivity provision unit illustrated in FIG. 2.

Referring to FIG. 4, the multi-cloud service management unit 220 may request the data connectivity provision unit 320 to support data connectivity between the cloud services in an initial multi-cloud service, which are provided by multiple different cloud service providers.

The data connectivity provision unit 320 may include a virtual storage manager 321 and a cloud storage connector 322.

The virtual storage manager 321 may check the received initial multi-cloud service, and may create a virtual storage unit to be shared among and used by the cloud services in the initial multi-cloud service.

The cloud storage connector 322 may connect multiple cloud storage units 30 provided by the different cloud service providers.

Here, the virtual storage manager 321 may create a virtual storage unit 324 having capacity required for the multi-cloud service by interworking with the resources of the actual cloud storage units 30 through the cloud storage connector 322.

Here, the virtual storage manager 321 may install virtual storage drivers 323 in each of the cloud services, thereby making settings such that all cloud services in the multi-cloud service are able to use the created virtual storage unit 324 by mounting the same.

Each of the cloud services mounts the generated virtual storage unit 324 using the installed virtual storage drivers 323, whereby data connectivity between the cloud services in the multi-cloud service may be realized as if the cloud services were using a storage unit provided by a single cloud service provider.

Here, the virtual storage manager 321 may provide various policies in order to minimize response delay, to provide the stability of data, and the like according to the purpose of use of the virtual storage of the multi-cloud service.

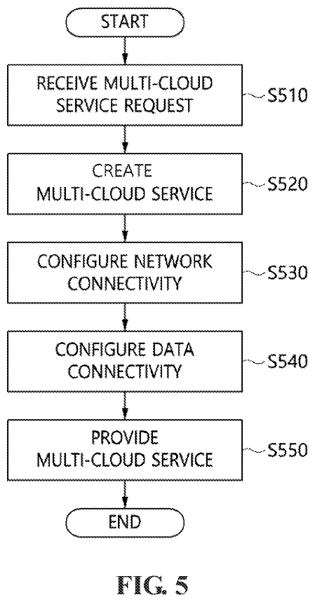

FIG. 5 is a flowchart illustrating a method for providing multi-cloud services according to an embodiment of the present invention.

Referring to FIG. 5, in the method for providing multi-cloud services according to an embodiment of the present invention, first, a request for a multi-cloud service may be received at step S510.

That is, at step S510, a service request for a multi-cloud service may be received from a user client 10, and a created multi-cloud service may be returned.

Also, in the method for providing multi-cloud services according to an embodiment of the present invention, a multi-cloud service may be created at step S520.

That is, at step S520, in response to the service request, a multi-cloud service may be created using multiple cloud services provided by different cloud service providers.

Here, at step S520, when the service request includes a request for interoperability between cloud services, an initially configured multi-cloud service may be delivered to the cloud service interoperability configuration unit 300.

Here, at step S520, functions for network connectivity or data connectivity between the cloud services are configured in order to support interoperability between the cloud services, and a multi-cloud service including the interoperability functions may be created.

Here, at step S520, the lifecycle of the created multi-cloud service may be managed.

Here, at step S520, when the multi-cloud service includes interoperability functions, whether the interoperability functions operates normally may be checked.

Also, in the method for providing multi-cloud services according to an embodiment of the present invention, network connectivity may be provided at step S530.

That is, at step S530, a virtual network between the multiple cloud services in the multi-cloud service is configured, whereby network connectivity may be provided.

Here, at step S530, the network connectivity between the cloud services in the multi-cloud service may be provided as in an environment of a single cloud service provider.

Here, at step S530, the virtual network may be configured using network information of each cloud service in order to avoid dependence on the different cloud service providers that actually provide the cloud services.

Here, at step S530, network connectivity between the cloud services in the initial multi-cloud service, which are provided by the multiple different cloud service providers may be established.

Here, at step S530, agents 313 are installed in each of the cloud services, and the installed agents 313 may store network information of each cloud service in a virtual network information storage unit 312.

Here, at step S530, each agent 313 may store the corresponding network information in a preset virtual network information storage unit 312.

Here, at step S530, when the preset virtual network information storage unit 312 is not available, the corresponding network information may be stored in alternative virtual network information storage unit 312.

Here, at step S530, whether the multi-cloud service information and network information of all cloud services in the multi-cloud service are stored in the virtual network information storage unit 312 may be checked.

Here, at step S530, when it is confirmed that the corresponding information are stored in the virtual network information storage unit 312, a new virtual network between the cloud services in the multi-cloud service may be set up, and the generated virtual network information may be stored in all of the virtual network information storage units 312.

Here, at step S530, the agents 313 installed in each of the cloud services may check whether the setup of the virtual network is completed through the virtual network information storage unit 312.

Here, at step S530, when it confirms that the setup of the virtual network is completed, the agent 313 may send and receive packets to and from other cloud services in the multi-cloud service based on the configured virtual network information.

Here, at step S530, because network information of the cloud service can be changed, whether the network information of the cloud services are changed may be periodically checked.

Here, at step S530, when changes in the network information are detected, the changes in the network information may be stored in the virtual network information storage unit 312.

Here, at step S530, all of the virtual network information storage units 312 are periodically checked, and when changes in the network information of any of the cloud services are detected, the virtual network information may be changed based on the changes in the network information and stored in all of the virtual network information storage units 312, whereby the changed virtual network information may be shared with other cloud services in the multi-cloud service.

Also, in the method for providing multi-cloud services according to an embodiment of the present invention, data connectivity may be provided at step S540.

That is, at step S540, data connectivity may be provided such that the multiple cloud services constituting the multi-cloud service are able to share and use data as in an environment of a single cloud service provider.

Here, at step S540, a virtual storage unit 324 that is formed by connecting cloud storage units 30 provided by different cloud service providers so as to interwork with each other may be configured and provided.

Here, at step S540, the multiple cloud services in the multi-cloud service may use the same virtual storage unit 324 by mounting the same.

Here, at step S540, data connectivity between the cloud services in the initial multi-cloud service, which are provided by the multiple different cloud service providers may be provided.

Here, at step S540, the received initial multi-cloud service is checked, and a virtual storage unit 324 to be shared among and used by the cloud services in the multi-cloud service may be created.

Here, at step S540, the multiple cloud storage units 30 provided by the different cloud service providers may be connected.

Here, at step S540, a virtual storage unit 324 having capacity required for the multi-cloud service may be created by interworking with the resources of the actual cloud storage units 30.

Here, at step S540, virtual storage drivers 323 are installed in each cloud services, and a setting may be made such that all cloud services in the multi-cloud service are able to use the created virtual storage unit 324 by mounting the same.

Here, at step S540, each of the cloud services mounts the created virtual storage unit 324 using the virtual storage driver 323, whereby data connectivity between the cloud services in the multi-cloud service may be provided as if the cloud services were using a storage unit provided by a single cloud service provider by mounting the same.

Here, at step S540, various policies for minimizing response delay, providing stability of data, and the like may be provided according to the purpose of use of the virtual storage unit of the multi-cloud service.

Also, in the method for providing multi-cloud services according to an embodiment of the present invention, the multi-cloud service may be provided at step S550.

That is, at step S550, the multi-cloud service created in response to the service request received from the user client 10 may be provided.

Here, at step S550, connections to the multiple different cloud service providers may be established.

Here, at step S550, in response to the request from the cloud service management unit 200, the created cloud services may be provided by the cloud service providers and delivered.

Here, at step S550, common interfaces may be provided for use in the same way for the different cloud service providers.

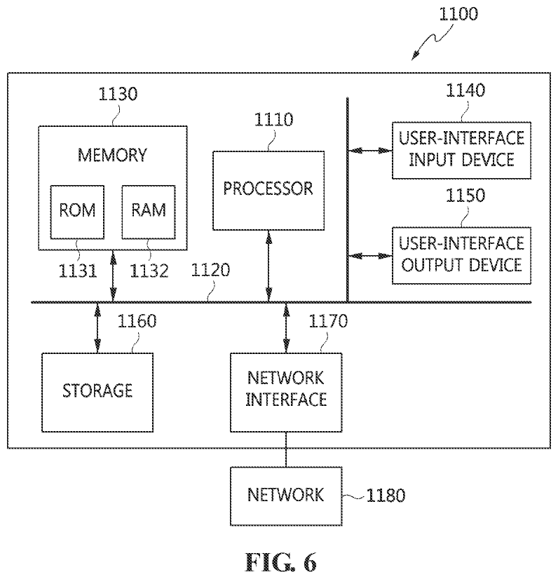

FIG. 6 is a view illustrating a computer system according to an embodiment of the present invention.

Referring to FIG. 6, the apparatus for providing interoperability of a multi-cloud service according to an embodiment of the present invention may be implemented in a computer system 1100 including a computer-readable recording medium. As illustrated in FIG. 6, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for providing interoperability of a multi-cloud service according to an embodiment of the present invention includes one or more processors 1110 and executable memory 1130 for storing at least one program executed by the one or more processors 1110, and the at least one program receives a service request for a multi-cloud service from a user client, creates a multi-cloud service in response to the service request, configures a function for interoperation between multiple cloud services for the multi-cloud service, and provides the multi-cloud service in which the function for interoperation is configured to the user client.

Here, the at least one program configures network connectivity by setting up a virtual network between the multiple cloud services and configures data connectivity by sharing a virtual storage unit between the multiple cloud services, thereby configuring the functions for interoperability.

Here, the at least one program may set up the virtual network using network information included in the multiple cloud services.

Here, when changes in the network information are detected, the at least one program may store the changes in the network information and share the same with the other cloud services.

Here, the at least one program may create the virtual storage unit by connecting cloud storage units provided by the cloud service providers of the multiple cloud services.

Here, the at least one program may create the virtual storage unit so as to have capacity required for the multi-cloud service based on the resources of the cloud storage units.

Here, the at least one program installs virtual storage drivers in the multiple cloud services, thereby mounting the virtual storage unit with the multiple cloud services.

The present invention may provide interoperability through network connectivity and data connectivity between the cloud services in the multi-cloud service provided by multiple different cloud service providers.

Also, the present invention may solve various problems that are caused when a cloud service customer uses cloud services provided by a single cloud service provider.

As described above, the apparatus and method for providing interoperability of a multi-cloud service according to the present invention are not limitedly applied to the configurations and operations of the above-described embodiments, but all or some of the embodiments may be selectively combined and configured, so that the embodiments may be modified in various ways.

What is claimed is:

1. An apparatus for providing interoperability of a multi-cloud service, comprising:
one or more processors; and
executable memory for storing at least one program executed by the one or more processors,
wherein the at least one program is configured to
receive a service request for a multi-cloud service from a user client,
create the multi-cloud service in response to the service request,
configure functions for interoperability between multiple cloud services in the multi-cloud service, and
provide the multi-cloud service in which the functions for interoperability are configured to the user client.

2. The apparatus of claim 1, wherein:
the at least one program configures network connectivity by setting up a virtual network between the multiple cloud services and configures data connectivity by sharing a virtual storage unit between the multiple cloud services, thereby configuring the functions for interoperability.

3. The apparatus of claim 2, wherein:
the at least one program sets up the virtual network using network information included in the multiple cloud services.

4. The apparatus of claim 3, wherein:
when changes in the network information of the multiple cloud services are detected, the at least one program stores the changes in the network information and shares the changes in the network information with the other cloud services in the multi-cloud service.

5. The apparatus of claim 2, wherein:
the at least one program creates the virtual storage unit by connecting cloud storage units provided by cloud service providers of the multiple cloud services.

6. The apparatus of claim 5, wherein:
the at least one program creates the virtual storage unit having capacity required for the multi-cloud service based on resources of the cloud storage units.

7. The apparatus of claim 6, wherein:
the at least one program installs virtual storage drivers in the multiple cloud services, thereby mounting the virtual storage unit with the multiple cloud services.

8. A method for providing interoperability of a multi-cloud service, performed by an apparatus for providing the interoperability of the multi-cloud service, the method comprising:
receiving a service request for a multi-cloud service from a user client,
creating the multi-cloud service in response to the service request,
configuring functions for interoperability between multiple cloud services in the multi-cloud service, and
providing the multi-cloud service in which the functions for interoperability are configured to the user client.

9. The method of claim 8, wherein configuring the functions for interoperability comprises:
configuring network connectivity by setting up a virtual network between the multiple cloud services; and
configuring data connectivity by sharing a virtual storage unit between the multiple cloud services.

10. The method of claim 9, wherein:
configuring the network connectivity is configured to set up the virtual network using network information included in the multiple cloud services.

11. The method of claim 10, wherein:
configuring the network connectivity is configured such that, when changes in the network information of the multiple cloud services are detected, the changes in the network information is stored and shared with the other cloud services.

12. The method of claim 9, wherein:
configuring the data connectivity is configured to create the virtual storage unit by connecting cloud storage units provided by cloud service providers of the multiple cloud services.

13. The method of claim 12, wherein:
configuring the data connectivity is configured to create the virtual storage unit having capacity required for the multi-cloud service based on resources of the cloud storage units.

14. The method of claim 13, wherein:
configuring the data connectivity is configured to install virtual storage drivers in the multiple cloud services, thereby mounting the virtual storage unit with the multiple cloud services.
